(19) United States
(12) Patent Application Publication
(10) Pub. No.: US 2026/0287925 A1
(43) Pub. Date: Sep. 24, 2026

(54) AR GLASSES HINGE STRUCTURE AND AR GLASSES HAVING THE SAME

(71) Applicant: META-BOUNDS INC., Zhuhai (CN)

(72) Inventor: Xiaodong HU, Zhuhai (CN)

(21) Appl. No.: 19/670,073

(22) Filed: May 7, 2026

Related U.S. Application Data
(63) Continuation of application No. PCT/CN2024/130251, filed on Nov. 6, 2024.

(30) Foreign Application Priority Data
Nov. 10, 2023 (CN) 202311503307.9

(51) Int. Cl. G02C 5/22

(52) U.S. Cl. CPC G02C 5/22

(57) ABSTRACT

The present disclosure belongs to the technical field of wearable devices and discloses an AR glasses hinge structure and AR glasses having the same. The AR glasses hinge structure includes a first arm, a second arm, a pivot member and an elastic member. The first arm provided with a receiving slot. The second arm is provided with an angle adjustment portion located within the receiving slot, and a plurality of angle adjustment surfaces are provided on an outer peripheral surface of the angle adjustment portion. The pivot member passes through the first arm and the second arm. A perpendicular distance from each angle adjustment surface to the pivot member is different. The elastic member contacts and presses against the angle adjustment surfaces. The second arm is driven to respectively abut against the elastic member, so as to adjust a relative position between the first arm and the second arm.

### CROSS-REFERENCE TO RELATED APPLICATIONS

The present disclosure claims priority to Chinese Patent disclosure No. 202311503307.9, filed on Nov. 10, 2023, and entitled “AN AR GLASSES HINGE STRUCTURE AND AR GLASSES HAVING THE SAME,” the entire disclosure of which is incorporated herein by reference.

### TECHNICAL FIELD

The present disclosure relates to the technical field of wearable devices, and more particularly, relates to an AR (Augmented Reality) glasses hinge structure and AR glasses having the same.

### BACKGROUND

AR glasses are smart glasses capable of merging virtual information with the real world. They include a frame, temples, and hinges, wherein the frame and the temples are connected via the hinge structures. AR glasses need to be worn continuously during use.

### SUMMARY

Embodiments of the present disclosure provide an AR glasses hinge structure and AR glasses having the same.

In a first aspect, an embodiment of the present disclosure provides an AR glasses hinge structure, which comprises: a first arm, a second arm, a pivot member and an elastic member. The first arm is provided with a receiving slot. One end of the second arm is provided with an angle adjustment portion, wherein the angle adjustment portion is located within the receiving slot, and a plurality of angle adjustment surfaces are provided on an outer peripheral surface of the angle adjustment portion. The pivot member is disposed within the receiving slot and passes through both the first arm and the second arm. The first arm and the second arm are rotatable relative to each other. A perpendicular distance from each of the angle adjustment surfaces to the pivot member is different, One end of the elastic member is received in the receiving slot, and another end of the elastic member is in contact with and presses against the angle adjustment surfaces. The second arm is configured to be driven to respectively abut against the elastic member at the plurality of angle adjustment surfaces when the second arm is subjected to an applied force, so as to adjust a relative position between the first arm and the second arm, The plurality of angle adjustment surfaces are located at different positions.

In a second aspect, an embodiment of the present disclosure provides AR glasses, which comprises a frame, temples, and the AR glasses hinge structure. The AR glasses hinge structure comprises: a first arm, a second arm, a pivot member and an elastic member. The first arm is provided with a receiving slot. One end of the second arm is provided with an angle adjustment portion, wherein the angle adjustment portion is located within the receiving slot, and a plurality of angle adjustment surfaces are provided on an outer peripheral surface of the angle adjustment portion. The pivot member is disposed within the receiving slot and passes through both the first arm and the second arm. The first arm and the second arm are rotatable relative to each other. A perpendicular distance from each of the angle adjustment surfaces to the pivot member is different, One end of the elastic member is received in the receiving slot, and another end of the elastic member is in contact with and presses against the angle adjustment surfaces. The second arm is configured to be driven to respectively abut against the elastic member at the plurality of angle adjustment surfaces when the second arm is subjected to an applied force, so as to adjust a relative position between the first arm and the second arm, The plurality of angle adjustment surfaces are located at different positions.. The frame is connected to the first arm of the hinge structure and the temples are connected to the second arm of the hinge structure; alternatively, the frame is connected to the second arm of the hinge structure and the temples are connected to the first arm of the hinge structure.

### BRIEF DESCRIPTION OF THE DRAWINGS

FIG. 1 is a schematic view of the overall structure of Embodiment 1 of an AR glasses hinge structure disclosed in the present disclosure.

FIG. 2 is a schematic cross-sectional view of Embodiment 1 of the AR glasses hinge structure disclosed in the present disclosure.

FIG. 3 is a schematic view of angle adjustment of Embodiment 1 of the AR glasses hinge structure disclosed in the present disclosure.

FIG. 4 is a schematic view of the overall structure of Embodiment 2 of an AR glasses hinge structure disclosed in the present disclosure.

FIG. 5 is a schematic cross-sectional view of Embodiment 2 of the AR glasses hinge structure disclosed in the present disclosure.

FIG. 6 is a schematic view of angle adjustment of Embodiment 2 of the AR glasses hinge structure disclosed in the present disclosure.

### DESCRIPTION OF REFERENCE NUMERALS

10, AR glasses hinge structure; D1, length direction of limit post/length direction of pivot member; D2, length direction of receiving slot/length direction of first arm; 1, first arm; 11, receiving slot; 12, limit post; 13, limit plate; 14, clearance; 15, notch; 16, mounting gap; 2, second arm; 21, angle adjustment portion; 22, angle adjustment surface; 221, initial adjustment surface; 222, transition adjustment surface; 223, positioning adjustment surface; 224, terminal adjustment surface; 23, connecting portion; 231, first positioning surface; 232, second positioning surface; 3, pivot member; 4, elastic member; 41, Mounting portion; 42, Deformation portion.

### DETAILED DESCRIPTION

The present disclosure is further described in detail below with reference to the accompanying drawings.

Embodiments of the present disclosure provide an Augmented Reality (AR) glasses hinge structure and AR glasses having the same.

### Embodiment 1

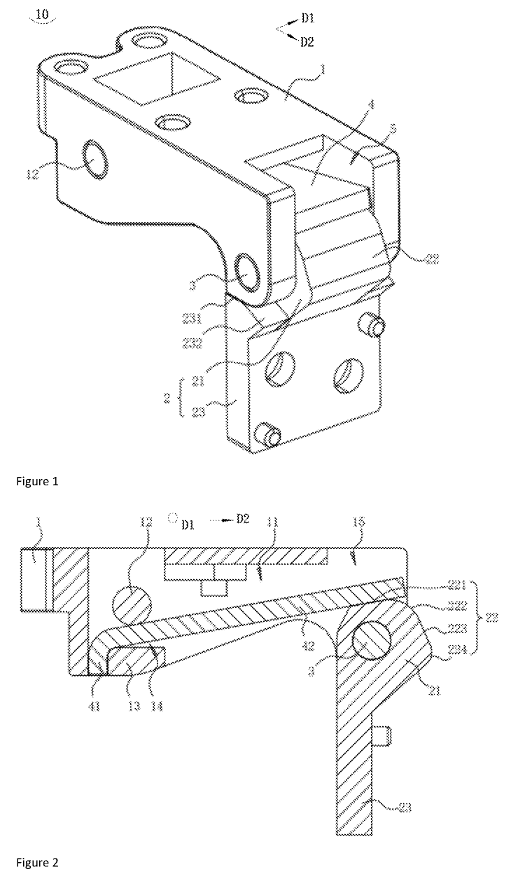

Referring to FIGS. 1 and 2, an AR glasses hinge structure 10 of this embodiment includes a first arm 1, a second arm 2, a pivot member 3, and an elastic member 4. The first arm 1 is provided with a receiving slot 11, the second arm 2 is located at one end of the first arm 1, and one end of the second arm 2 is provided with an angle adjustment portion 21 which is located within the receiving slot 11. A plurality of angle adjustment surfaces 22 are provided on the peripheral wall of the angle adjustment portion 21. In this embodiment, a plurality of angle adjustment surfaces 22 are provided on the outer peripheral surface of the angle adjustment portion 21. The pivot member 3 is disposed on the first arm 1 and passes through both the first arm 1 and the second arm 2, allowing the first arm 1 and the second arm 2 to rotate relative to each other. In this embodiment, the pivot member 3 is disposed within the receiving slot 11. The perpendicular distance from each angle adjustment surface 22 to the pivot member 3 is different. One end of the elastic member 4 is mounted on the first arm 1, and another end of the elastic member 4 is in contact with and presses against the second arm 2. By adjusting the different contact surfaces where the elastic member 4 contacts and presses against the second arm 2, the angle between the first arm 1 and the second arm 2 is adjusted.

One end of the elastic member 4 is mounted on the first arm 1, and another end of the elastic member 4 is in contact with and presses against an angle adjustment surface 22. When the second arm 2 is subjected to an applied force, the position where the elastic member 4 contacts and presses against the angle adjustment surface 22 changes to adjust the included angle between the first arm 1 and the second arm 2. In this embodiment, one end of the elastic member 4 is received in the receiving slot 11, and another end of the elastic member 4 is in contact with and presses against an angle adjustment surface 22. The second arm 2 is configured to be driven to respectively abut against the elastic member 4 at the plurality of angle adjustment surfaces 22 when the second arm 2 is subjected to an applied force, so as to adjust the relative position between the first arm 1 and the second arm 2, wherein the plurality of angle adjustment surfaces 22 are at different positions. In this embodiment, one end of the elastic member 4 is received in the first arm 1, and the second arm 2 is provided with a plurality of contact surfaces. Another end of the elastic member 4 is in contact with and presses against a contact surface of the second arm 2. By rotating the second arm 2, the contact surface where the elastic member 4 contacts and presses against the second arm 2 can be adjusted, thereby adjusting the relative position between the first arm 1 and the second arm 2.

Specifically, the first arm 1 is provided with a receiving slot 11 and a notch 15 communicating with the receiving slot 11. The receiving slot 11 is used to accommodate the elastic member 4, and the notch 15 is used to provide clearance for the movement path of the elastic member 4, so that the elastic member 4 is not obstructed within the angle adjustment range. The receiving slot 11 extends along the length direction D2 of the first arm 1, the notch 15 of the receiving slot 11 faces the second arm 2, and the notch 15 is located at the end of the first arm 1 near the second arm 2.

The pivot member 3 is located within the receiving slot 11, the length direction D1 of the pivot member 3 is perpendicular to the length direction D2 of the receiving slot 11, and two ends of the pivot member 3 are respectively mounted on the first arm 1. The two ends of the pivot member 3 are provided with limit caps (not shown) to prevent the pivot member 3 from detaching from the first arm 1.

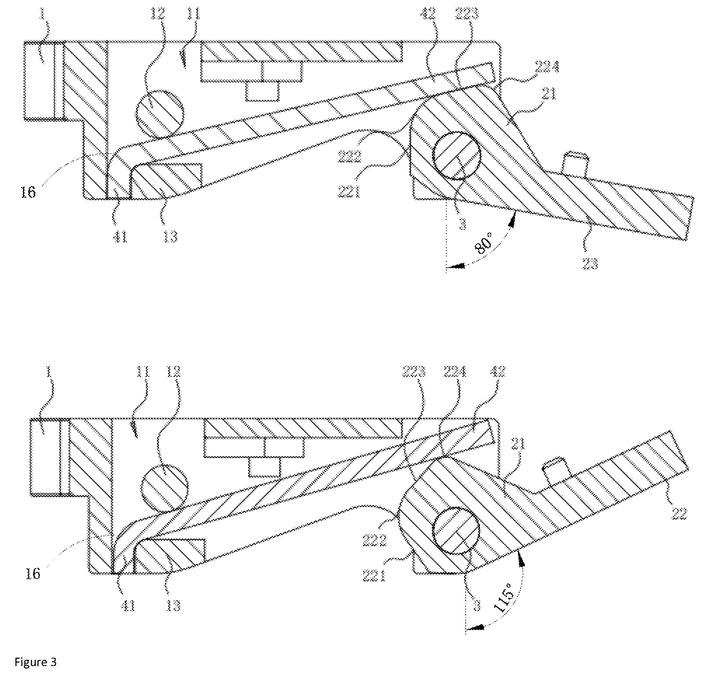

Referring to FIGS. 2 and 3, the second arm 2 includes an angle adjustment portion 21 and a connecting portion 23, the angle adjustment portion 21 is located at the end of the second arm 2 near the first arm 1, the angle adjustment portion 21 is located within the receiving slot 11, and the pivot member 3 passes through the angle adjustment portion 21. The connecting portion 23 is integrally formed with the angle adjustment portion 21.

A plurality of angle adjustment surfaces 22 are provided on the outer peripheral surface of the angle adjustment portion 21, and the perpendicular distance from each angle adjustment surface 22 to the pivot member 3 is different. The connecting portion 23 can rotate relative to the first arm 1 about the pivot member 3. During rotation, as the angle between the first arm 1 and the second arm 2 increases, when the various angle adjustment surfaces 22 sequentially abut against the elastic member 4, the perpendicular distance between the center of the pivot member 3 and the plane of each angle adjustment surface 22 in contact with the elastic member 4 also gradually increases.

When a force is exerted on the connecting portion 23, the angle adjustment portion 21 rotates relative to the first arm 1. The angle adjustment surface 22 abutting against the elastic member 4 is subjected to a force, causing the elastic member 4 to deform and generate a resilient force. The resilient force of the elastic member 4 presses against the angle adjustment surface 22 to position and lock the current relative position between the first arm 1 and the second arm 2. In this embodiment, the angle adjustment surfaces 22 include, in a clockwise direction, an initial adjustment surface 221, a transition adjustment surface 222, a positioning adjustment surface 223, and a terminal adjustment surface 224. The transition adjustment surface 222 and the terminal adjustment surface 224 are curved surfaces, while the initial adjustment surface 221 and the positioning adjustment surface 223 are planar surfaces. In other embodiments, depending on the setting of the adjustment angle, a plurality of positioning adjustment surfaces 223 may be provided, with transition adjustment surfaces 222 provided between adjacent positioning adjustment surfaces 223 for transition.

The elastic member 4 is L-shaped and includes a mounting portion 41 and a deformation portion 42 which are integrally formed. The mounting portion 41 is located at the end of the first arm 1 away from the second arm 2. In this embodiment, the mounting portion 41 is disposed within the receiving slot 11 at the end away from the second arm 2. The end of the deformation portion 42 away from the mounting portion 41 presses against the angle adjustment portion 21. The elastic member 4 is located within the receiving slot 11. In this embodiment, the deformation portion 42 is located within the receiving slot 11. As the angle between the first arm 1 and the second arm 2 gradually increases, the amount of deformation occurring in the deformation portion 42 also gradually increases. In this embodiment, the deformation portion 42 is located within the receiving slot 11, and the perpendicular distance between the end of the deformation portion 42 and the plane where the end of the mounting portion 41 is located gradually increases as the adjustment angle increases. In this embodiment, the elastic member 4 is preferably a spring sheet.

The adjustment angle between the first arm 1 and the second arm 2 is 80° to 115°. When the deformation portion 42 is in contact with and presses against the initial adjustment surface 221, the angle between the first arm 1 and the second arm 2 is at a minimum. At this time, the first arm 1 and the second arm 2 are perpendicular to each other, and the adjustment angle between the first arm 1 and the second arm 2 is 0°, as shown in FIG. 2. When the angle between the first arm 1 and the second arm 2 needs to be adjusted, a force is applied to the connecting portion 23, causing the angle adjustment portion 21 to press against the deformation portion 42 and cause the deformation portion 42 to deform. At this time, the contact surface between the angle adjustment portion 21 and the deformation portion 42 can switch from the initial adjustment surface 221 through the transition adjustment surface 222 to the positioning adjustment surface 223. At this time, the adjustment angle between the first arm 1 and the second arm 2 is 80°, as shown in FIG. 3. When a force continues to be applied to the connecting portion 23 until the deformation portion 42 contacts and presses against the terminal adjustment surface 224, the maximum adjustment angle between the first arm 1 and the second arm 2 is reached. At this time, the adjustment angle between the first arm 1 and the second arm 2 is 115°, as shown in FIG. 3. To accommodate different head sizes of users, a corresponding force can be applied to the connecting portion 23 to adjust the included angle between the first arm 1 and the second arm 2 so as to adapt to different users, thereby enhancing wearing comfort and user experience. Simultaneously, the mutual cooperation of the elastic member 4 and the angle adjustment portion 21 achieves a simplified and lightweight rotating structure, thereby reducing the weight of the AR glasses and enhancing wearing comfort. Correspondingly, a reduction in the space occupied by the hinge structure allows for more choices in temples dimension and appearance, so that the aesthetic appeal of the product can be enhanced.

Continuing to refer to FIG. 1, in order to limit the range of the adjustment angle between the first arm 1 and the second arm 2, and to enable positioning and self-locking when the angle between the first arm 1 and the second arm 2 is at the maximum and minimum adjustment angles, the connecting portion 23 is provided with a first positioning surface 231 and a second positioning surface 232, both of which are planar surfaces. The connecting portion 23 is provided with the first positioning surface 231, and the angle adjustment surfaces 22 include the initial adjustment surface 221. When the elastic member 4 is in contact with and presses against the initial adjustment surface 221, the angle between the first arm 1 and the second arm 2 is at a minimum, and the first arm 1 is in contact with and presses against the first positioning surface 231. In this embodiment, when the deformation portion 42 is in contact with and presses against the initial adjustment surface 221, the first arm 1 and the second arm 2 are perpendicular to each other and the first arm 1 is in contact with and presses against the first positioning surface 231, thereby locking the minimum angle between the first arm 1 and the second arm 2. The connecting portion 23 is provided with the second positioning surface 232, and the angle adjustment surfaces 22 include the terminal adjustment surface 224. When the elastic member 4 is in contact with and presses against the terminal adjustment surface 224, the angle between the first arm 1 and the second arm 2 is at a maximum, and the first arm 1 is in contact with and presses against the second positioning surface 232. In this embodiment, when the deformation portion 42 is in contact with and presses against the terminal adjustment surface 224, the maximum adjustment angle between the first arm 1 and the second arm 2 is reached, and the first arm 1 is in contact with and presses against the second positioning surface 232. In this embodiment, the first positioning surface 231 contacts and presses against the lower end surface of the first arm 1, and the second positioning surface 232 contacts and presses against the right-side end surface of the first arm 1.

Referring to FIG. 2, in order to increase the resilient force of the elastic member 4, the first arm 1 is provided with a limit post 12. The limit post 12 is located within the receiving slot 11 and mounted at the end of the first arm 1 away from the second arm 2. The length direction D1 of the limit post 12 is perpendicular to the length direction D2 of the receiving slot 11, two ends of the limit post 12 are respectively fixedly connected to two opposite side walls of the receiving slot 11, and the limit post 12 is located on the movement path of the deformation portion 42. During the angle adjustment process, a force is applied to the second arm 2. As the angle between the first arm 1 and the second arm 2 increases, the deformation portion 42 abuts against the angle adjustment portion 21 such that the distance between the deformation portion 42 and the pivot member 3 gradually increases, and the degree of deformation of the deformation portion 42 gradually increases. The limit post 12 pressing against the deformation portion 42 increases the resilient force of the deformation portion 42, thereby increasing the reaction force of the end of the deformation portion 42 against the angle adjustment surface 22. That is, when the positioning adjustment surface 223 on the second arm 2 is rotated to a preset angle adjustment surface 22 under the action of an external force, and the external force is then released, the second arm 2 is subjected to a greater resilient force applied by the deformation portion 42, which can lock the relative position between the first arm 1 and the second arm 2 at that time.

Further, as shown in FIG. 3, the first arm 1 is further provided with a limit plate 13, and the limit plate 13 is located within the receiving slot 11 and is parallel to the limit post 12, with the limit plate 13 being located directly below the limit post 12. A clearance 14 is provided between the limit plate 13 and the limit post 12. The deformation portion 42 is located within the clearance 14 formed by the limit post 12 and the limit plate 13, and two sides of the deformation portion 42 respectively contact and press against the limit post 12 and the limit plate 13. At the end of the receiving slot 11 on the first arm 1 away from the notch 15, a mounting gap 16 is provided between the inner wall of the receiving slot 11 and the limit plate 13. The end of the mounting portion 41 away from the notch 15 is assembled within the mounting gap 16, and the end of the mounting portion 41 away from the notch 15 simultaneously abuts against the inner wall of the receiving slot 11 and the limit plate 13. During the deformation process of the deformation portion 42, the limit plate 13 restricts the movement tendency of the mounting portion 41, and the limit post 12 moderates the degree of deformation of the deformation portion 42. The mutual cooperation of the limit plate 13 and the limit post 12 enhances the stability of the elastic member 4. In this embodiment, the elastic member 4 is mounted within the receiving slot 11 of the first arm 1 through the joint restriction of the limit plate 13 and the limit post 12.

The working principle of Embodiment 1 is as follows: an external force is applied to the connecting portion 23, and the angle adjustment portion 21 rotates relative to the first arm 1 under the action of the external force. An angle adjustment surface 22 on the angle adjustment portion 21 abuts against the elastic member 4 and applies a force to it, causing the elastic member 4 to deform. The amount of deformation of the deformation portion 42 of the elastic member 4 also gradually increases, and thus the resilient force generated by the elastic deformation of the deformation portion 42 presses against the angle adjustment surface 22 to lock the relative position between the first arm 1 and the second arm 2.

### Embodiment 2

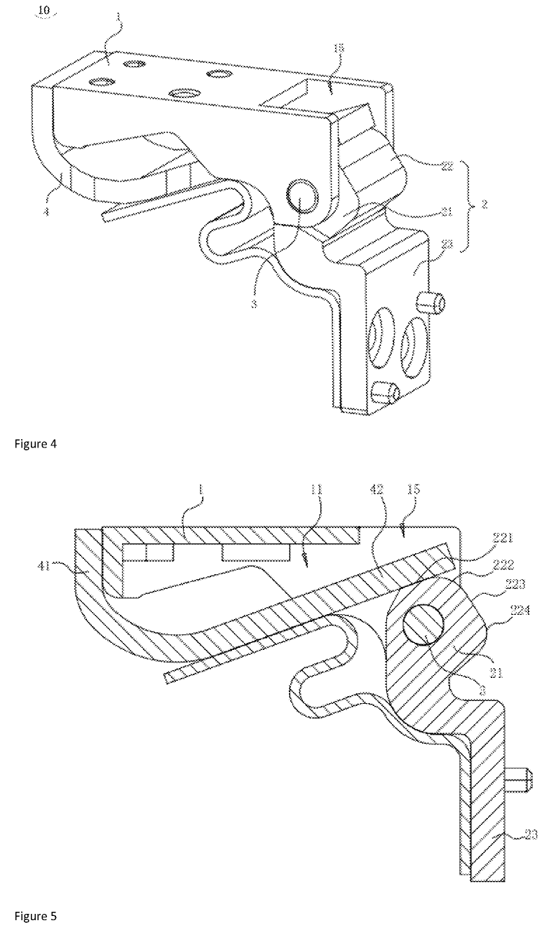

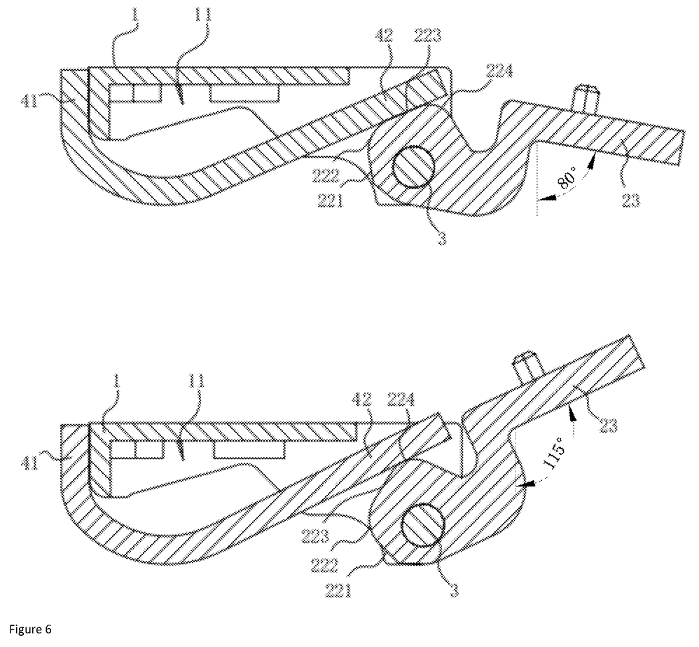

Referring to FIGS. 4 and 5, this embodiment differs from Embodiment 1 in that the mounting portion 41 of the elastic member 4 is located outside the receiving slot 11 and is fixedly connected to the first arm 1, and the side of the deformation portion 42 away from the mounting portion 41 is located within the receiving slot 11 and is in contact with and presses against the angle adjustment surface 22. As the angle between the first arm 1 and the second arm 2 increases, the perpendicular distance between the side of the deformation portion 42 away from the mounting portion 41 and the plane where the end of the mounting portion 41 is located gradually decreases. As shown in FIG. 5, when the deformation portion 42 is in contact with and presses against the initial adjustment surface 221, the angle between the first arm 1 and the second arm 2 is at a minimum. At this time, the first arm 1 and the second arm 2 are perpendicular to each other, and the adjustment angle between the first arm 1 and the second arm 2 is 0°. When the angle between the first arm 1 and the second arm 2 needs to be adjusted, a force is applied to the connecting portion 23, and the angle adjustment portion 21 presses against the deformation portion 42 under the action of the external force to cause the deformation portion 42 to deform. At this time, under the action of the external force, the contact surface between the angle adjustment portion 21 and the deformation portion 42 can switch from the initial adjustment surface 221 through the transition adjustment surface 222 to the positioning adjustment surface 223. At this time, the adjustment angle between the first arm 1 and the second arm 2 is 80°, as shown in FIG. 6. When a force continues to be applied to the connecting portion 23 until the deformation portion 42 contacts and presses against the terminal adjustment surface 224, the maximum adjustment angle between the first arm 1 and the second arm 2 is reached. At this time, the adjustment angle between the first arm 1 and the second arm 2 is 115°, as shown in FIG. 6.

In Embodiment 1, the elastic member 4 bends outward when not under force, while in Embodiment 2, the elastic member 4 bends inward when not under force. When the bending direction of the L-shaped elastic member 4 under force is the same as its initial bending direction when not under force, the arrangement of its internal molecules becomes tighter. Therefore, under the same external force, the elastic member 4 will more easily return to its initial state, generating a greater resilient force. Thus, when the bending direction of the elastic member 4 under force is the same as its initial bending direction when not under force, the resilient force of the elastic member 4 will be greater as compared to that when the bending directions are opposite. Therefore, the resilient force of the elastic member 4 in Embodiment 1 is greater than that in Embodiment 2, thereby exerting a greater force on the angle adjustment surface 22. Once the angle adjustment between the first arm 1 and the second arm 2 is completed, the angle between the first arm 1 and the second arm 2 is more stable. In practical disclosures, the clamping force of the elastic member 4 on the second arm 2 can be adjusted by changing the thickness, hardness, and lever arm angle of the elastic member 4.

The implementation principle of Embodiment 2 is as follows: an external force is applied to the connecting portion 23, and the angle adjustment portion 21 rotates relative to the first arm 1 under the action of the external force so that the angle adjustment surface 22 on the first arm 1 can apply a force to the elastic member 4, causing the elastic member 4 to deform and generate a resilient force. When the angle adjustment surface 22 is rotated to the positioning adjustment surface 223 corresponding to a preset angle under the action of the external force and the external force is then released, the planar positioning adjustment surface 223 will hinder the rotation of the connecting portion 23 because there is an angular difference between the planar positioning adjustment surface 223 and the adjacent curved transition adjustment surface 222. At the same time, the resilient force generated by the deformation of the deformation portion 42 will press against the positioning adjustment surface 223, thereby achieving positioning and locking of the relative position between the first arm 1 and the second arm 2 at that time.

An embodiment of the present disclosure discloses AR glasses. The AR glasses include the AR glasses hinge structure 10 of any of the above embodiments, a frame, and temples. The frame is connected to the first arm 1 of the hinge structure and the temples are connected to the second arm 2 of the hinge structure. Alternatively, the frame is connected to the second arm 2 of the hinge structure and the temples are connected to the first arm 1 of the hinge structure.

The above are preferred embodiments of the present disclosure and are not intended to limit the scope of protection of the present disclosure. Identical parts are denoted by the same reference numerals. It should be noted that the words “front”, “back”, “left”, “right”, “upper” and “lower” used in the above description refer to directions in the drawings, and the words “inner” and “outer” refer to directions toward or away from the geometric center of a specific component, respectively. Therefore, any equivalent changes made according to the structure, shape, and principle of the present disclosure shall be covered within the scope of protection of the present disclosure.

1. An AR glasses hinge structure, comprising:
a first arm provided with a receiving slot;
a second arm, one end of the second arm being provided with an angle adjustment portion, wherein the angle adjustment portion is located within the receiving slot, and a plurality of angle adjustment surfaces are provided on an outer peripheral surface of the angle adjustment portion;
a pivot member, being disposed within the receiving slot and passing through both the first arm and the second arm, wherein the first arm and the second arm are rotatable relative to each other; wherein a perpendicular distance from each of the angle adjustment surfaces to the pivot member is different;
and an elastic member, one end of the elastic member being received in the receiving slot, and another end of the elastic member being in contact with and pressing against the angle adjustment surfaces; wherein the second arm is configured to be driven to respectively abut against the elastic member at the plurality of angle adjustment surfaces when the second arm is subjected to an applied force, so as to adjust a relative position between the first arm and the second arm, and wherein the plurality of angle adjustment surfaces are located at different positions.

2. The AR glasses hinge structure according to claim 1, wherein the elastic member comprises a mounting portion and a deformation portion, wherein the mounting portion and the deformation portion are integrally formed, wherein the mounting portion is disposed within the receiving slot at an end away from the second arm, and the elastic member is L-shaped.

3. The AR glasses hinge structure according to claim 2, wherein the deformation portion is located within the receiving slot, and as an angle between the first arm and the second arm gradually increases, an amount of deformation occurring in the deformation portion also gradually increases.

4. The AR glasses hinge structure according to claim 3, wherein the first arm is provided with a limit post, wherein the limit post is located within the receiving slot and mounted at an end of the first arm away from the second arm, wherein a length direction of the limit post is perpendicular to a length direction of the receiving slot, wherein two ends of the limit post are respectively fixedly connected to two opposite side walls of the receiving slot, and the limit post is located on a movement path of the deformation portion.

5. The AR glasses hinge structure according to claim 4, wherein the first arm is provided with a limit plate, wherein the limit plate is located within the receiving slot and is parallel to the limit post, wherein the limit plate is located directly below the limit post; wherein a clearance is provided between the limit plate and the limit post, wherein the deformation portion is located within the clearance formed by the limit post and the limit plate, and two sides of the deformation portion respectively contact and press against the limit post and the limit plate.

6. The AR glasses hinge structure according to claim 5, wherein the first arm is provided with a notch communicating with the receiving slot; wherein at an end of the receiving slot on the first arm away from the notch, a mounting gap is provided between an inner wall of the receiving slot and the limit plate, wherein an end of the mounting portion away from the notch is assembled within the mounting gap, and the end of the mounting portion away from the notch simultaneously abuts against the inner wall of the receiving slot and the limit plate.

7. The AR glasses hinge structure according to claim 2, wherein an adjustment angle between the first arm and the second arm is 80° to 115°.

8. The AR glasses hinge structure according to claim 1, wherein the second arm is further provided with a connecting portion, wherein the connecting portion and the angle adjustment portion are integrally formed, wherein the connecting portion is provided with a first positioning surface; wherein the angle adjustment surfaces comprise an initial adjustment surface, and when the elastic member is in contact with and presses against the initial adjustment surface, the angle between the first arm and the second arm is at a minimum, and the first arm is in contact with and presses against the first positioning surface.

9. The AR glasses hinge structure according to claim 8, wherein the connecting portion is provided with a second positioning surface, wherein the angle adjustment surfaces comprise a terminal adjustment surface, and when the elastic member is in contact with and presses against the terminal adjustment surface, the angle between the first arm and the second arm is at a maximum, and the first arm is in contact with and presses against the second positioning surface.

10. AR glasses, comprising a frame, temples, and an AR glasses hinge structure;
wherein the AR glasses hinge structure comprises a first arm, a second arm, a pivot member and an elastic member; wherein the first arm is provided with a receiving slot; wherein one end of the second arm is provided with an angle adjustment portion; wherein the angle adjustment portion is located within the receiving slot, and a plurality of angle adjustment surfaces are provided on an outer peripheral surface of the angle adjustment portion; wherein the pivot member is disposed within the receiving slot and passes through both the first arm and the second arm, wherein the first arm and the second arm are rotatable relative to each other; wherein a perpendicular distance from each of the angle adjustment surfaces to the pivot member is different; wherein one end of the elastic member is received in the receiving slot, and another end of the elastic member is in contact with and presses against the angle adjustment surfaces; wherein the second arm is configured to be driven to respectively abut against the elastic member at the plurality of angle adjustment surfaces when the second arm is subjected to an applied force, so as to adjust a relative position between the first arm and the second arm, and wherein the plurality of angle adjustment surfaces are located at different positions;
wherein the frame is connected to the first arm of the hinge structure and the temples are connected to the second arm of the hinge structure; alternatively, the frame is connected to the second arm of the hinge structure and the temples are connected to the first arm of the hinge structure.

11. The AR glasses according to claim 10, wherein the elastic member comprises a mounting portion and a deformation portion, wherein the mounting portion and the deformation portion are integrally formed, wherein the mounting portion is disposed within the receiving slot at an end away from the second arm, and the elastic member is L-shaped.

12. The AR glasses according to claim 11, wherein the deformation portion is located within the receiving slot, and as an angle between the first arm and the second arm gradually increases, an amount of deformation occurring in the deformation portion also gradually increases.

13. The AR glasses according to claim 12, wherein the first arm is provided with a limit post, wherein the limit post is located within the receiving slot and mounted at an end of the first arm away from the second arm, wherein a length direction of the limit post is perpendicular to a length direction of the receiving slot, wherein two ends of the limit post are respectively fixedly connected to two opposite side walls of the receiving slot, and the limit post is located on a movement path of the deformation portion.

14. The AR glasses according to claim 13, wherein the first arm is provided with a limit plate, wherein the limit plate is located within the receiving slot and is parallel to the limit post, wherein the limit plate is located directly below the limit post; wherein a clearance is provided between the limit plate and the limit post, wherein the deformation portion is located within the clearance formed by the limit post and the limit plate, and two sides of the deformation portion respectively contact and press against the limit post and the limit plate.

15. The AR glasses according to claim 14, wherein the first arm is provided with a notch communicating with the receiving slot; wherein at an end of the receiving slot on the first arm away from the notch, a mounting gap is provided between an inner wall of the receiving slot and the limit plate, wherein an end of the mounting portion away from the notch is assembled within the mounting gap, and the end of the mounting portion away from the notch simultaneously abuts against the inner wall of the receiving slot and the limit plate.

16. The AR glasses according to claim 11, wherein an adjustment angle between the first arm and the second arm is 80° to 115°.

17. The AR glasses according to claim 10, wherein the second arm is further provided with a connecting portion, wherein the connecting portion and the angle adjustment portion are integrally formed, wherein the connecting portion is provided with a first positioning surface; wherein the angle adjustment surfaces comprise an initial adjustment surface, and when the elastic member is in contact with and presses against the initial adjustment surface, the angle between the first arm and the second arm is at a minimum, and the first arm is in contact with and presses against the first positioning surface.

18. The AR glasses according to claim 17, wherein the connecting portion is provided with a second positioning surface, wherein the angle adjustment surfaces comprise a terminal adjustment surface, and when the elastic member is in contact with and presses against the terminal adjustment surface, the angle between the first arm and the second arm is at a maximum, and the first arm is in contact with and presses against the second positioning surface.
